(19) United States
(12) Patent Application Publication
(10) Pub. No.: US 2023/0304905 A1
(43) Pub. Date: Sep. 28, 2023

(54) SAMPLE PREPARATION FOR EXPANSION MICROSCOPY

(71) Applicant: HOWARD HUGHES MEDICAL INSTITUTE, Chevy Chase, MD (US)

(72) Inventors: Paul Tillberg, Ashburn, VA (US); Boaz Mohar, Ashburn, VA (US)

(21) Appl. No.: 18/188,930

(22) Filed: Mar. 23, 2023

Related U.S. Application Data
(60) Provisional application No. 63/322,915, filed on Mar. 23, 2022.

(51) Int. Cl. G01N 1/30; G01N 1/36; G02B 21/34

(52) U.S. Cl. CPC G01N 1/30; G01N 1/36; G02B 21/34; G01N 2001/305

(57) ABSTRACT

Methods of imaging biomolecules from a tissue sample are described, including methods for preparing a tissue sample for imaging using expansion microscopy, while achieving ultrahigh effective imaging resolution.

### RELATED APPLICATIONS

This application claims priority from U.S. Provisional Application Ser. No. 63/322,915 filed Mar. 23, 2022, the entire disclosure of which is incorporated herein by this reference.

### TECHNICAL FIELD

The presently-disclosed subject matter generally relates to methods of imaging biomolecules from a tissue sample. In particular, certain embodiments of the presently-disclosed subject matter relate to methods for preparing a tissue sample for imaging using expansion microscopy, while achieving ultrahigh effective imaging resolution.

### INTRODUCTION

Targeting reagents, such as antibodies, are useful tools for biomolecule imaging and can be used to selectively label molecular targets of interest, such as proteins, nucleotides, or other biomolecules in a tissue sample. For example, antibodies can be employed to selectively label a specific protein of interest, such as a protein with specific post-translational modifications or another modified or unmodified protein within a biological specimen.

Imaging can be conducted using a targeting reagent that has been functionalized with a contrast agent, such as a fluorescent dye. Several strategies exist to generate targeting reagents directed to apparently arbitrary targets, such as by immunizing an animal to create antibodies, in vitro selection processes to create aptamers, and other known methods. Such tools are useful for research in various areas of biology. However, there are a number of drawbacks associated with targeting reagents.

Localization error, or the difference between determined and true position, is one drawback associated with targeting regents. The localization error is largely due to the finite size of the targeting reagent, which is ˜24 nm for antibodies (including both a primary and a secondary antibody). Developments in expansion microscopy imaging have been able to reduce localization error by applying targeting reagents after physically swelling the tissue sample in a highly absorbent gel material¹⁻³. However, localization error is not the only drawback. A more fundamental limitation may be termed the fixation tradeoff. Strong fixation is required to preserve tissue structure, and especially for high quality ultrastructure, but this strong fixation also reduces the ability of targets to be bound by targeting reagents due to increased chemical modification and steric hindrance. Thus, the fixation tradeoff involves sacrificing imaging quality either by neglecting the ultrastructure of the tissue sample or limiting binding of imaging reagents to the target biomolecule.

Accordingly, there remains a need in the art for tools for imaging a target biomolecule within a tissue sample, which allow for both ultrahigh effective imaging resolution; and high quality antibody staining, in multiple rounds of antibody or affinity reagent application and washout.

### SUMMARY

The presently-disclosed subject matter meets some or all of the above-identified needs, as will become evident to those of ordinary skill in the art after a study of information provided in this document.

This Summary describes several embodiments of the presently-disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this Summary or not. To avoid excessive repetition, this Summary does not list or suggest all possible combinations of such features.

The presently-disclosed subject matter includes a method of preparing a tissue sample for imaging a target biomolecule within the tissue sample with a targeting reagent, which involves treating the tissue sample with a chemical fixative; treating the tissue sample with a first anchor for attaching the target biomolecule to a linear polymer to be synthesized subsequently; treating the tissue sample with a polymerization solution to be polymerized to generate the linear polymer, wherein the polymerization solution comprises first monomers, which are monomers of the linear polymer, and a first component of a second anchor having: a first moiety for incorporating into the linear polymer, and a second moiety for reacting with a second component of the second anchor; allowing the first monomers in the solution to polymerize and link to the target biomolecule via the first anchor, treating the tissue sample with the second component of the second anchor having: a first moiety that is reactive with the second moiety of the first component of the second anchor for engaging the first component of the second anchor, and a second moiety for incorporating into a swellable hydrogel; incubating the tissue sample with a gelation solution to be polymerized to generate a swellable hydrogel, wherein the gelation solution comprises second monomers, which are monomers of the swellable hydrogel, and a cross-linker; and allowing the swellable hydrogel to form, wherein the second component of the second anchor is incorporated into the swellable hydrogel via the second moiety of the second component of the second anchor, thereby embedding the tissue sample and the target biomolecule within the swellable hydrogel.

In some embodiments of the method, the second anchor comprises the first moiety of the first component of the second anchor that is an acryloyl moiety (Ac) for incorporating into the linear polymer; the second moiety of the first component of the second anchor that is an azido moiety for reacting with the second component of the second anchor; the first moiety of the second component of the second anchor that is an azido-reactive moiety for engaging the first component of the second anchor; and the second moiety of the second component of the second anchor that is an acryloyl moiety (Ac) for incorporating into a swellable hydrogel.

Some embodiments of the method further comprise slicing the tissue sample before treatment with the second component of the second anchor.

In some embodiments of the method, the swellable hydrogel is an ultra-swellable hydrogel.

Some embodiments of the method further comprise expanding the swellable hydrogel.

Some embodiments of the method further comprise treating the tissue sample embedded within the swellable hydrogel with a disruption buffer prior to expanding the swellable hydrogel. In some embodiments, the disruption buffer comprises a protein denaturing reagent and a reducing agent. In some embodiments, the protein denaturing reagent is selected from the group consisting of sodium dodecyl sulfate (SDS), urea, guanidium HCl; and the reducing agent is selected from the group consisting of dithiothreitol (DTT), tris(2-carboxyethyl)phosphine (TCEP), and sodium sulfite.

Some embodiments of the method further comprise contacting the tissue sample with a targeting reagent specific for the target biomolecule. In some embodiments, the targeting reagent comprises an antibody, a nanobody, an aptamer, or an oligonucleotide.

Some embodiments of the method further comprise imaging the tissue sample.

In some embodiments of the method, the chemical fixative is selected from the group consisting of: formaldehyde, glutaraldehyde, and glyoxal.

In some embodiments of the method, the linear polymer is selected from the group consisting of: polyacrylamide, polymethylacrylate, poly(N-isopropylacrylamide), polysulfobetainemethacrylate, and co-polymers thereof

In some embodiments of the method, the first anchor is selected from the group consisting of: glutaraldehyde, methacryloyl-N-hydroxysulfosuccinimide (MA-NETS), 6-((Acryloyl)amino)hexanoic acid succinimidyl ester (AcX), and combinations of formaldehyde and acrylamide. In some embodiments, the first anchor is melphalan reacted with AcX or MA-NETS, and the target biomolecule is RNA.

In some embodiments of the method, the polymerization solution comprises an initiator to initiate polymerization and an accelerator to catalyze polymerization. In some embodiments, the polymerization solution also comprises an inhibitor to delay polymerization. The initiator and accelerator of the polymerization solution can include, for example ammonium peroxodisulfate and tetramethylethylenediamine (APS/TEMED) The inhibitor can be, for example, 4-hydroxy TEMPO radical inhibitor.

In some embodiments of the method, the polymerization solution comprises 2-Hydroxy-4′-(2-hydroxyethoxy)-2-methylpropiophenone (UV initiator), and/or 2,2′-Azobis[2-(2-imidazolin-2-yl)propane]dihydrochloride (VA-044).

In some embodiments of the method, the polymerization solution further comprises a cleavable cross-linker. The cleavable cross-linker can be, for example, bis(acryloyl)cystamine (BAC) or N,N′-(1,2-Dihydroxyethylene)bis-acrylamide (DHEBA).

In some embodiments of the method, the azido-reactive moiety of the second component of the second anchor compound is a diarylcyclooctyne (DBCO) moiety.

In some embodiments of the method, the second moiety of the first component of the second anchor, and the first moiety of the second component of the second anchor, are click chemistry pairs. In some embodiments, the second moiety of the first component of the second anchor, and the first moiety of the second component of the second anchor are selected from the group consisting of: azido-DBCO include alkene-tetrazine (e.g. TCO-tetrazine), 6-hydrazinonicotinate acetone hydrazone-4formyl benzamide (HyNic-4FB), and copper-catalyzed azide-alkyne.

In some embodiments of the method, the swellable hydrogel is a polylectrolyte gel, for example a polyacrylate gel, or poly 2-acrylamido-2-methylpropane sulfonic acid (poly AMPS) gel, including copolymers with a non-electrolyte monomer for example acrylamide.

In some embodiments of the method, the gelation solution comprises an initiator to initiate polymerization and an accelerator to catalyze polymerization. In some embodiments, the gelation solution comprises an inhibitor to delay polymerization. In some embodiments, the initiator and accelerator of the gelation solution include ammonium peroxodisulfate and tetramethylethylenediamine (APS/TEMED). In some embodiments, the gelation solution comprises 4-hydroxy TEMPO radical inhibitor. In some embodiments, the gelation solution comprises 2-Hydroxy-4′-(2-hydroxyethoxy)-2-methylpropiophenone (UV initiator), and/or 2,2′-Azobis[2-(2-imidazolin-2-yl)propane]dihydrochloride (VA-044).

Some embodiments of the method further comprise placing the tissue sample embedded within the swellable hydrogel in a chamber and incubating with a stabilizing gelation solution comprising monomers of a swellable stabilizing gel. In some embodiments, the stabilizing gelation solution further comprises a UV initiator or a chemical initiator. In some embodiments, the stabilizing gelation solution further comprises a cross-linker.

In some embodiments, the monomers of the swellable stabilizing gel are selected from the group consisting of: acrylamide, sodium acrylate, poly 2-Acrylamido-2-methylpropane sulfonic acid (poly AMPS), and combinations thereof. In some embodiments, the UV initiator or chemical initiator is selected from the group consisting of: 2-hydroxy-2-methylpropiophenon, APS/TEMED, lithium phenyl (2,4,6-trimethylbenzoyl) phosphinate (LAP), and combinations thereof. In some embodiments, the cross-linker is selected from the group consisting of: bisacrylamide, N,N′-ethylenebis(acrylamide), poly(ethylene glycol) diacrylate, and combinations thereof.

Some embodiments of the method further comprise placing the tissue sample embedded within the swellable stabilizing gel in a chamber and incubating with an immobilization gelation solution comprising monomers of an immobilization gel. In some embodiments, the immobilization gelation solution further comprises a UV initiator or a chemical initiator. In some embodiments, the immobilization gelation solution further comprises a cross-linker.

In some embodiments, the monomers of the immobilization gel are selected from the group consisting of: acrylamide, polymethylacrylate, poly(N-isopropylacrylamide), polysulfobetainemethacrylate, and combinations thereof. In some embodiments, the UV initiator or chemical initiator is selected from the group consisting of: 2-hydroxy-2-methylpropiophenon, APS/TEMED, lithium phenyl (2,4,6-trimethylbenzoyl) phosphinate (LAP), and combinations thereof. In some embodiments, the cross-linker is selected from the group consisting of: bisacrylamide, N,N′-ethylenebis(acrylamide), poly(ethylene glycol) diacrylate, and combinations thereof.

In some embodiments of the method, the tissue sample is obtained from an animal. In some embodiments, the tissue sample is an organ slice or a whole organ. In some embodiments, the tissue sample is obtained from a mouse, zebrafish larvae, or drosophila brain. In some embodiments, the tissue sample is obtained from live brain slices.

In some embodiments of the method, the tissue sample is obtained from cultured cells. In some embodiments, the cultured cells are primary cells. In some embodiments, the cultured cells are immortalized cells.

In some embodiments of the method, any combination of the fixative, first anchor, and polymerization solution are delivered to the specimen by transcardial perfusion.

In some embodiments, the dose of chemical fixative is substantially lower than in standard methods, e.g. 6% formaldehyde applied for several minutes, vs. several hours.

In some embodiments of the method, the target biomolecule is selected from the group consisting of a protein, a nucleotide, and a cell surface carbohydrate.

In some embodiments when the target biomolecule is a protein, the protein is a protein with post-translational modifications, a structural protein such as a synaptic scaffold protein, a protein marking a structure such as TOMM20 marks mitochondria, or a protein that carry out a biochemical function such as a neurotransmitters transporter.

In some embodiments when the target biomolecule is a nucleotide, the nucleotide is selected from the group consisting of DNA and RNA, including mRNA and other RNA molecules.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are used, and the accompanying drawings of which:

FIG. 1. Schematic representation of the steps in an exemplary method in accordance with the presently-disclosed subject matter.

FIGS. 2A and 2B. Schematic depictions of biomolecules of a tissue sample associated and attached to various reagents used in an exemplary method in accordance with the presently-disclosed subject matter.

FIGS. 3A and 3B. FIG. 3A: Image of mouse brain cortex antibody stained using a method as disclosed herein for microtubule-associated protein 2 (MAP2), vesicular GABA transporter (VGAT), and calcium channel (CaV2.1), using conventional primary and secondary antibodies and imaged using confocal fluorescence microscopy. FIG. 3B: Zoom-in of image of FIG. 3A, showing details of dendritic spines filled with VGAT.

FIG. 4A-4D. Images of mouse brain cortex processed using a method as disclosed herein and antibody stained for Homer, VGAT, and bassoon after staining (FIGS. 4A and 4C), after stripping off antibodies (FIG. 4B), and after re-staining with the same antibodies and imaging in a different field of view within the same tissue (FIG. 4D).

### DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

The presently-disclosed subject matter includes methods for preparing a tissue sample for imaging a target biomolecule and methods of imaging biomolecules from a tissue sample. Some embodiments of the presently-disclosed subject matter include methods for preparing a tissue sample for imaging using expansion microscopy, while achieving ultrahigh effective imaging resolution.

The presently-disclosed subject matter provides tools useful for imaging a target biomolecule within a tissue sample, which allow for both ultrahigh effective imaging resolution, and high quality antibody staining, in multiple rounds of antibody or affinity reagent application and washout.

The presently-disclosed subject matter includes a method of preparing a tissue sample for imaging a target biomolecule within the tissue sample with a targeting reagent.

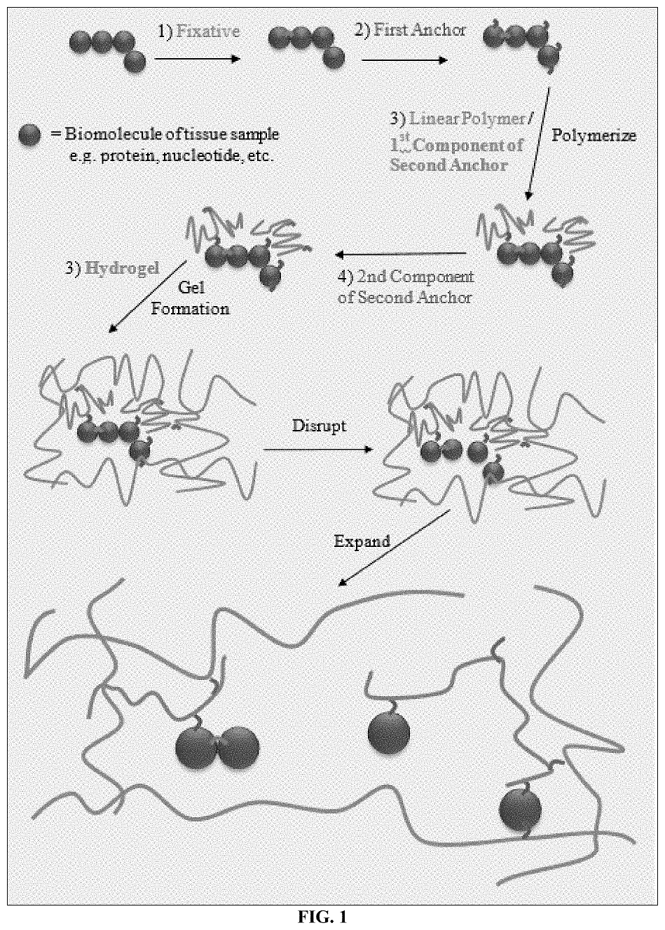

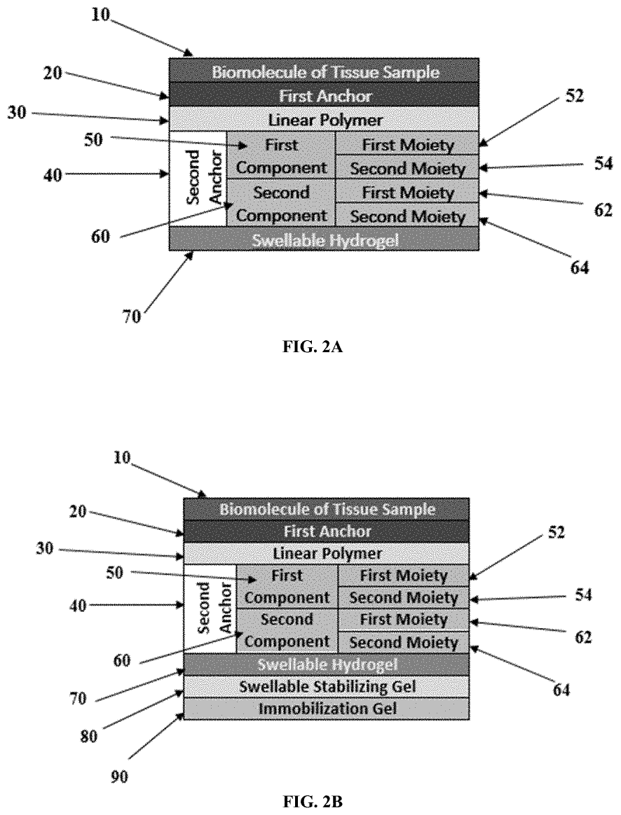

Briefly, with reference to FIG. 1 and FIG. 2A-2B, the tissue sample is treated with a chemical fixative, and treated with a first anchor 20 that is used to attach the target biomolecule 10 to a linear polymer 30 that is synthesized by incubating the sample with a polymerization solution. The linear polymer 30 is then joined via a second anchor 40 to a swellable hydrogel 70 that is synthesized by incubating the sample with a gelation solution. With continued reference to FIG. 1, the swellable hydrogel can then be treated with a disruption buffer. The swellable hydrogel can then be expanded.

With reference to FIG. 2B, in some embodiments, a swellable stabilizing gel 80 can also be used to stabilize the swellable hydrogel 70. Such stabilization can facilitate, for example, repeated rounds of antibody staining and stripping. With continued reference to FIG. 2B, in some embodiments, an immobilization gel 90 can also be used to immobilize the embedded and expanded tissue sample to a support structure. Such immobilization can facilitate, for example, stable imaging across multiple rounds of antibody application and stripping.

While not depicted, the method can further involve contacting the sample with a targeting reagent specific for the target biomolecule. The method can further involve imaging the sample.

With regard to the fixation step, various known chemical fixatives known in the art can be used. For example, in some embodiments, the chemical fixative can be formaldehyde, glutaraldehyde, or glyoxal. In standard tissue sample fixation methods of the prior art, 4% formaldehyde is often used, but some methods employ about 3% to about 6% formaldehyde, with fixation taking place for about 10-20 minutes for cultured cells and 2 hours or more for tissue such as an organ slice. For example, a common standard method is fixation in 4% formaldehyde overnight. However, as will be appreciated by the skilled artisan upon review of this document, one of the features of the presently-disclosed subject matter is the ability to use a dose of chemical fixative and timeframe for fixation that is substantially lower than in standard methods. For example, in connection with the presently-disclosed subject matter about 3-6% formaldehyde for about 2-10 minutes could be used. In this regard, the presently-disclosed subject matter helps when navigating the so-called fixation tradeoff challenge.

Turning to the step of treating the sample with the first anchor, with reference to FIG. 1 and FIG. 2A-2B, the first anchor 20 is used for attaching the target biomolecule 10 to a linear polymer 30 that will be subsequently synthesized. The first anchor is appropriately selected depending on the type of biomolecule being targeted. For example, in some embodiments, the first anchor is selected from the group consisting of: glutaraldehyde, methacryloyl-N-hydroxysulfosuccinimide (MA-NETS), 6-((Acryloyl)amino)hexanoic acid succinimidyl ester (AcX), and combinations of formaldehyde and acrylamide. In some embodiments where the target biomolecule is RNA, the first anchor can be, for example, AcX or MA-NETS.

The linear polymer 30 is synthesized and attached to the first anchor 20 by treating the sample with a polymerization solution for generating the linear polymer 30. The polymerization solution comprises monomers of the linear polymer. Various monomers of polymers can be selected in accordance with the presently-disclosed subject matter. For example, in some embodiments, the linear polymer is selected from the group consisting of: polyacrylamide, polymethylacrylate, poly(N-isopropylacrylamide), polysulfobetainemethacrylate, and co-polymers thereof. The monomers in the polymerization solution are allowed to polymerize and link to the target biomolecule 10 via the first anchor 20.

In some embodiments, the polymerization solution can contain additional components. For example, in some embodiments, the polymerization solution comprises an initiator to initiate polymerization and an accelerator to catalyze polymerization. Various initiators and accelerators are known in the art and can be appropriately selected for use in the presently-disclosed subject matter. For example, in some embodiments, the initiator and accelerator of the polymerization solution can include ammonium peroxodisulfate and tetramethylethylenediamine (APS/TEMED).

In some embodiments, the polymerization solution comprises an inhibitor to delay polymerization, which can be useful to facilitate ease of handling and transferring a tissue sample that is being treated. In some embodiments, the polymerization solution can contain, for example, 4-hydroxy TEMPO radical inhibitor. In some embodiments, the polymerization solution can contain, for example, 2-Hydroxy-4′-(2-hydroxyethoxy)-2-methylpropiophenone (UV initiator), and/or 2,2′-Azobis[2-(2-imidazolin-2-yl)propane]dihydrochloride (VA-044). In some embodiments, the polymerization solution can include a cleavable cross-linker. The cleavable cross-linker can be selected, for example, from bis(acryloyl)cystamine (BAC) and N,N′-(1,2-Dihydroxyethylene)bis-acrylamide (DHEBA).

Referring again to FIG. 1 and FIG. 2A-2B, the second anchor 40 is used for attaching the linear polymer 30 to the swellable hydrogel 70 that will be subsequently synthesized. In this regard, in addition to the monomers of the linear polymer 30, the polymerization solution can also contain a first component 50 of a second anchor 40. For purposes of clarity, the second anchor 40 will be described in great detail with reference to FIG. 2.

As shown in FIG. 2A-2B, the second anchor 40 includes a first component 50 and a second component 60. The first component 50 includes a first moiety 52 for incorporating into the linear polymer 30, and therefore it is useful to include the first component 50 in the polymerization solution, as noted above. The first component 50 also includes a second moiety 54 for reacting with the second component 60 of the second anchor 40.

After the sample is treated with the polymerization solution, such that the biomolecule 10 is attached to the linear polymer 30 via the first anchor 20, and the first component 50 of the second anchor 40 is incorporated into the linear polymer 30 via its first moiety 52, the sample can be treated with the second component 60 of the second anchor 40.

With continued reference to FIG. 2A-2B, the second component 60 of the second anchor 40 includes a first moiety 62 and a second moiety 64. The first moiety 62 of the second component 60 is reactive with the second moiety 54 of the first component 50. The second moiety 64 of the second component 60 is for incorporating into the swellable hydrogel 70. Accordingly, the second anchor 40 is positioned to link the linear polymer 30 to the swellable hydrogel 70, which will be subsequently synthesized.

In some embodiments of the second anchor 40, the first moiety 52 of the first component 50 is an acryloyl moiety (Ac) for incorporating into the linear polymer 50, and the second moiety 64 of the second component 60 is an acryloyl moiety (Ac) for incorporating into a swellable hydrogel 70.

In some embodiments of the second anchor 40, the second moiety 54 of the first component 50 is an azido moiety, and the first moiety 62 of the second component 60 is an azido-reactive moiety, such that the azido moiety and azido-reactive moiety engage with one another.

In some embodiments of the second anchor 40, the second moiety 54 of the first component 50 and the first moiety 62 of the second component 60 are click chemistry pairs. For example, in some embodiments, they are selected from azido-DBCO include alkene-tetrazine (e.g. TCO-tetrazine), 6-hydrazinonicotinate acetone hydrazone-4formyl benzamide (HyNic-4FB), and copper-catalyzed azide-alkyne.

Turning back to FIG. 1, the sample is next incubated with a gelation solution. The gelation solution comprises monomers of the swellable hydrogel and a cross-linker. The swellable hydrogel is allowed to form and, as depicted in FIG. 2, the second component 60 of the second anchor 40 is incorporated into the swellable hydrogel 70 via the second moiety 64.

Thus, as schematically represented in FIG. 2, the biomolecule 10 of the tissue sample is joined to the linear polymer 30 by the first anchor 20. The linear polymer 30 is joined to the swellable hydrogel 70 by the second anchor 40. More particularly, the first moiety 52 of the first component 50 of the second anchor 40 interacts with the linear polymer 30. The second moiety 54 of the first component 50 interacts with the first moiety 62 of the second component 60 of the second anchor 40. Finally, the second moiety 64 of the second component 60 of the second anchor 40 interacts with the swellable hydrogel 70. Accordingly, the tissue sample and target biomolecule 10 are incorporated with the swellable hydrogel 70.

In some embodiments of the presently-disclosed subject matter, the swellable hydrogel is an ultra-swellable hydrogel. In some embodiments of the presently-disclosed subject matter, the swellable hydrogel is a polylectrolyte gel, for example a polyacrylate gel, or poly 2-Acrylamido-2-methylpropane sulfonic acid (poly AMPS) gel, including copolymers with a non-electrolyte monomer for example acrylamide.

In some embodiments of the presently-disclosed subject matter, in addition to monomers of the swellable hydrogel and a cross-linker, the gelation solution comprises an initiator to initiate polymerization and an accelerator to catalyze polymerization. Various initiators and accelerators are known in the art and can be appropriately selected for use in the presently-disclosed subject matter. For example, in some embodiments, the initiator and accelerator of the gelation solution can include ammonium peroxodisulfate and tetramethylethylenediamine (APS/TEMED).

In some embodiments, the gelation solution further comprises an inhibitor to delay polymerization. In certain circumstances it can be desirable to delay polymerization, for example, when the tissue sample is a tissue slice, it can be desirable to delay polymerization to allow time for the monomers of the swellable hydrogel, and any other components of the gelation solution, to diffuse into the tissue slice.

In some embodiments of the presently-disclosed subject matter, the gelation solution can include a 4-hydroxy TEMPO radical inhibitor. In some embodiments, the gelation solution comprises 2-Hydroxy-4′-(2-hydroxyethoxy)-2-methylpropiophenone (UV initiator), and/or 2,2′-Azobis[2-(2-imidazolin-2-yl)propane] dihydrochloride (VA-044).

With reference to FIG. 2B, in some embodiments, after the tissue sample and the target biomolecule are embedded within the swellable hydrogel 70, the tissue sample embedded within the swellable hydrogel 70 is placed within a chamber and incubating with a stabilizing gelation solution including monomers of a swellable stabilizing gel 80. In some embodiments, the monomers of the swellable stabilizing gel 80 are selected, for example, from the group consisting of: acrylamide, sodium acrylate, poly 2-Acrylamido-2-methylpropane sulfonic acid (poly AMPS), and combinations thereof.

In some embodiments, in addition to monomers of the swellable stabilizing gel 80, the stabilization gelation solution can also include a UV initiator or a chemical initiator. The UV initiator or a chemical initiator can be selected, for example, from 2-hydroxy-2-methylpropiophenon, APS/TEMED, lithium phenyl (2,4,6-trimethylbenzoyl) phosphinate (LAP), and combinations thereof.

In some embodiments, the stabilization gelation solution can also include a cross-linker. The cross-linker can be selected, for example, from bisacrylamide, N,N′-ethylenebis(acrylamide), poly(ethylene glycol) diacrylate, and combinations thereof

With continued reference to FIG. 2B, in some embodiments, after the tissue sample and the target biomolecule are embedded within the swellable stabilizing gel 80, the tissue sample embedded within the swellable stabilizing gel 80 is placed within a chamber and incubated with an immobilization gelation solution including monomers of an immobilization gel 90. In some embodiments, the monomers of the immobilization gel 90 are selected, for example, from the group consisting of acrylamide, polymethylacrylate, poly(N-isopropylacrylamide), polysulfobetainemethacrylate, and combinations thereof.

In some embodiments, in addition to monomers of the immobilization gel 90, the immobilization gelation solution can also include a UV initiator or a chemical initiator. The UV initiator or a chemical initiator can be selected, for example, from 2-hydroxy-2-methylpropiophenon, APS/TEMED, lithium phenyl (2,4,6-trimethylbenzoyl) phosphinate (LAP), and combinations thereof.

In some embodiments, the immobilization gelation solution can also include a cross-linker. The cross-linker can be selected, for example, bisacrylamide, N,N′-ethylenebis(acrylamide), poly(ethylene glycol) diacrylate, and combinations thereof.

With reference again to FIG. 1, the swellable hydrogel can then be treated with a disruption buffer. The swellable hydrogel can then be expanded. While not specifically depicted in FIG. 1, the method can further involve contacting the sample with a targeting reagent specific for the target biomolecule. The method can further involve imaging the sample.

In some embodiments, the disruption buffer comprises a protein denaturing reagent and a reducing agent. In some embodiments, the protein denaturing reagent is selected from sodium dodecyl sulfate (SDS), urea, guanidium HCl; and the reducing agent is selected from the group consisting of dithiothreitol (DTT), tris(2-carboxyethyl)phosphine (TCEP), and sodium sulfite.

With regard to the targeting reagent, as will be appreciated by the skilled artisan, it can be selected in view of the nature of the particular target biomolecule of interest. For example, in some embodiments, the targeting reagent can include an antibody, a nanobody, an aptamer, or an oligonucleotide. As will also be appreciated by the skilled artisan, there are various types of imaging and imaging tools known in the art that could be selected for appropriate use in accordance with the presently-disclosed subject matter, depending, at least, on the selection of tissue sample, target biomolecule, and targeting reagent.

As noted herein, the presently-disclosed subject matter can be used in connection with a number of distinct tissue sample types. For example, the tissue sample could be obtained from an animal. In this regard, the tissue sample could an organ slice or a whole organ. The tissue sample could be obtained from various animal sources including, but not limited to, a mouse, zebrafish larvae, or drosophila brain. In some embodiments, the tissue sample could be obtained from cultured cells. In some embodiments, the cultured cells are primary cells. In some embodiments, the cultured cells are immortalized cells. In some embodiments, the tissue sample is obtained from live brain slices.

Depending on the particular tissue sample being employed, as will be appreciated by the skilled artisan, appropriate sample preparation and/or treatment can be employed. For example, in some embodiments, the method can involve slicing the tissue sample before treatment with the second component of the second anchor. In some embodiments of the method, any combination of the fixative, first anchor, and polymerization solution can be delivered to the specimen by transcardial perfusion.

Furthermore, the presently-disclosed subject matter can be used in connection with a number of distinct target biomolecules. For example, the target biomolecule can be selected from the group consisting of a protein, a nucleotide, and a cell surface carbohydrate. Additionally, in embodiments in which the target biomolecule is a protein, it can be selected from, for example, a protein with post-translational modifications, a structural protein such as a synaptic scaffold protein, a protein marking a structure such as TOMM20 marks mitochondria, or a protein that carry out a biochemical function such as a neurotransmitters transporter. Additionally, in embodiments in which the target biomolecule is a nucleotide, it can be selected from, for example, DNA and RNA, including mRNA and other RNA molecules, e.g., miRNA, dsRNA, etc.

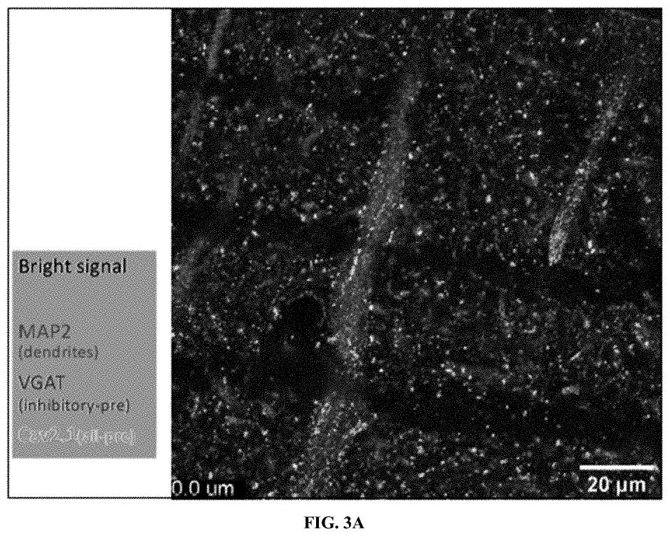

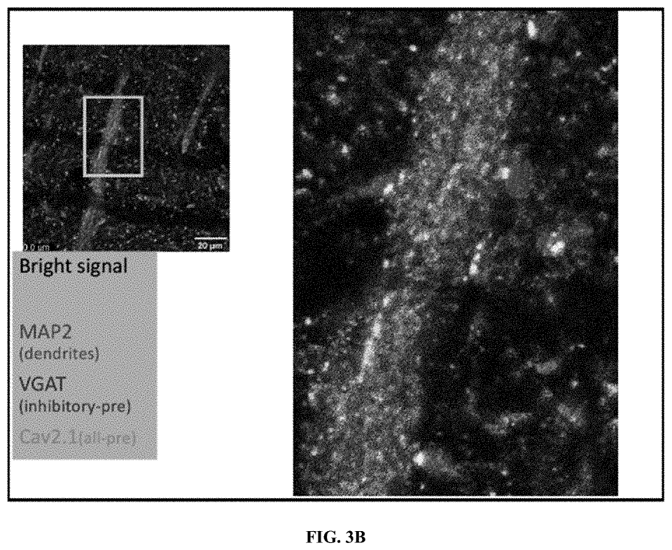

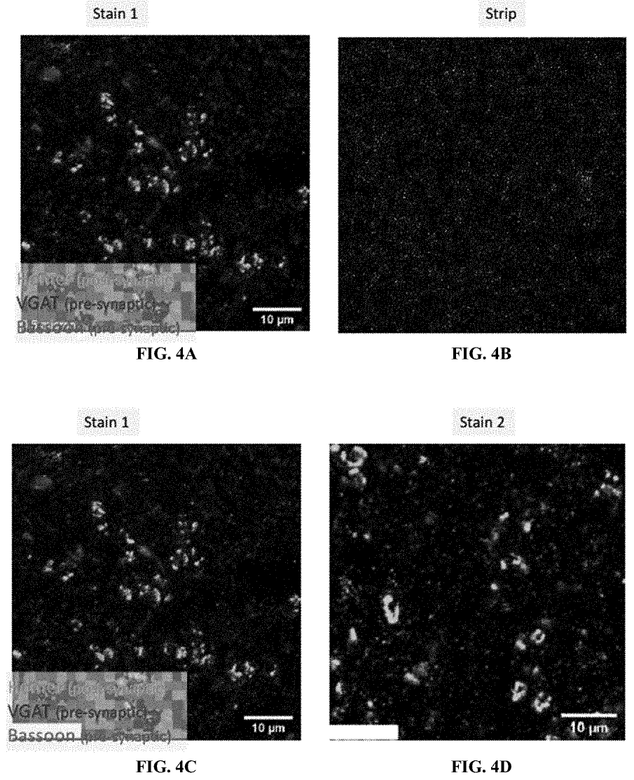

Exemplary images obtained from samples prepared using the method of the presently-disclosed subject matter can be found in FIGS. 3A, 3B, and 4A-4D. FIG. 3A includes an image of mouse brain cortex antibody stained using a method as disclosed herein for microtubule-associated protein 2 (MAP2), vesicular GABA transporter (VGAT), and calcium channel (CaV2.1), using conventional primary and secondary antibodies and imaged using confocal fluorescence microscopy. FIG. 3B is a zoom-in of the image of FIG. 3A, showing details of dendritic spines filled with VGAT.

FIG. 4A-4D include a series of images of mouse brain cortex processed using a method as disclosed herein and antibody stained for Homer, VGAT, and bassoon after staining (FIGS. 4A and 4C), after stripping off antibodies (FIG. 4B), and after re-staining with the same antibodies and imaging in a different field of view within the same tissue (FIG. 4D).

While the terms used herein are believed to be well understood by those of ordinary skill in the art, certain definitions are set forth to facilitate explanation of the presently-disclosed subject matter.

Unless defined otherwise, all technical and scientific terms used herein have the same meaning as is commonly understood by one of skill in the art to which the invention(s) belong.

All patents, patent applications, published applications and publications, GenBank sequences, databases, websites and other published materials referred to throughout the entire disclosure herein, unless noted otherwise, are incorporated by reference in their entirety.

Where reference is made to a URL or other such identifier or address, it understood that such identifiers can change and particular information on the internet can come and go, but equivalent information can be found by searching the internet. Reference thereto evidences the availability and public dissemination of such information.

As used herein, the abbreviations for any protective groups, amino acids and other compounds, are, unless indicated otherwise, in accord with their common usage, recognized abbreviations, or the IUPAC-IUB Commission on Biochemical Nomenclature (see, Biochem. (1972) 11(9):1726-1732).

Although any methods, devices, and materials similar or equivalent to those described herein can be used in the practice or testing of the presently-disclosed subject matter, representative methods, devices, and materials are described herein.

The present application can “comprise” (open ended) or “consist essentially of” the components of the present invention as well as other ingredients or elements described herein. As used herein, “comprising” is open ended and means the elements recited, or their equivalent in structure or function, plus any other element or elements which are not recited. The terms “having” and “including” are also to be construed as open ended unless the context suggests otherwise.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, in some embodiments ±0.1%, in some embodiments ±0.01%, and in some embodiments ±0.001% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, “optional” or “optionally” means that the subsequently described event or circumstance does or does not occur and that the description includes instances where said event or circumstance occurs and instances where it does not. For example, an optionally variant portion means that the portion is variant or non-variant.

The presently-disclosed subject matter is further illustrated by the following specific but non-limiting examples. The following examples may include compilations of data that are representative of data gathered at various times during the course of development and experimentation related to the present invention.

### EXAMPLES

### Example 1: Sample Collection and Preparation

A research animal is transcardially perfused with, sequentially, formaldehyde for rapid chemical fixation, methacryloyl-NHS for protein anchoring, and then acrylamide gelation solution with APS/TEMED free radical initiator/accelerator pair for polymerization.

The tissue of interest is dissected and placed in a chamber purged with inert gas to remove oxygen and left to polymerize. The polymerization solution contains bis(acryloyl)cystamine, a cleavable cross-linker, to improve ease of handling of the polymer-fixed specimen.

The polymerization solution contains a small molecule (azido-Ac) bearing an acryloyl moiety for incorporation into a polyacrylamide polymer (a linear polymer), and an azide moiety for later functionalization and incorporation into a polyelectrolyte gel (a swellable hydrogel).

The polymerized tissue is then sliced and treated with a small molecule (DBCO-Ac) bearing a DBCO moiety for attachment to an anchor via the azide groups and an acryloyl for incorporation into the polyelectrolyte gel.

The tissue is then incubated with polylectrolyte gelation solution (containing monomers, initiator/accelerator, etc.) and gelled, to create the final ultraswellable hydrogel with proteins and potentially other biomolecules incorporated through the polyacrylamide polymer.

### Example 2: Expanding and Imaging

The embedded tissue is then treated with a disruption buffer with a high concentration of harsh detergent (SDS) and reducing agent (DTT) at a high temperature (80° C. for 3 hours), as in a Western blot preparation. This treatment denatures proteins, allowing uniform expansion by the polyelectrolyte gel, reducing steric hindrance between biomolecules and possibly reversing chemical fixation (e.g. via formaldehyde, but not the strong covalent attachment to the polymer).

After washing out the detergent, affinity reagents (e.g. antibodies) may be applied to the embedded tissue sample using standard immunohistochemical techniques, with or without additional modifications.

Due to the strong covalent attachment of biomolecules to a uniform gel network, harsh stripping conditions may be employed to fully remove affinity regents and apply a new set of affinity reagents, in repeated rounds of stripping, staining, and imaging. If a common target is included in all rounds, this can be used to register rounds to each other in order to create a composite image with many colors of affinity reagents imaged in the same tissue volume, at an effective spatial resolution given by the resolution limit of the microscope improved by the physical expansion factor of the specimen itself (e.g. 8×).

### Example 3: Stabilizing Gel

The tissue sample embedded within the swellable hydrogel is further encapsulated in a swellable stabilizing gel. After embedding the tissue sample in the swellable hydrogel, disrupting with disruption buffer, and thoroughly washing out the disruption buffer, the embedded sample is equilibrate with 1×PBS. Further embedding the sample in a swellable stabilizing gel will stabilize and toughen the sample to facilitate repeated rounds of antibody staining and stripping.

A swellable stabilizing gel monomer solution is provided. A UV initiator or chemical initiator is added to the monomer solution just before use. The swellable hydrogel sample is weighed and 1×PBS is added up to a total amount of 50 uL (assuming the gel density is 1 g/ml). The swellable stabilizing gel monomer solution with initiator (450 uL) is added. These volumes may be scaled up and down while maintaining their ratio. The combination is incubated with shaking for 30 min.

The swellable hydrogel sample is sandwiched between a glass slide and a coverslip, using dabs of vacuum grease at the corners of the coverslip to immobilize it. The swellable hydrogel sample may be confined to a region of the glass slide by placing pieces of scotch tape on the slide around the second gel prior to applying the vacuum grease and cover slip.

The remaining volume between the slide and the coverslip is filled with swellable stabilizing gel monomer solution, such that the edge of the second gel is at least 3 mm away from any open side between the slide and the cover slip.

The fully assembled gelation chamber is placed in a UV curing oven for 30 min, or until the swellable stabilizing gel has formed. The gel is recovered and excess gel is trimmed away with a razor blade. The swellable stabilizing gel is expanded with several thorough washes of 1 mM HEPES buffer adjusted to pH ˜7.3 (i.e. close to its pKa).

### Example 4: Immobilization Gel

An immobilization gel can also be used, such as a non-expanding polyacrylamide gel that can be formed around the edge of the stabilizing gel and used to immobilize the specimen to a holder for stable imaging across multiple rounds of antibody application and stripping. The non-expanding gel further partially pins the gel in the fully expanded state in one or two dimensions.

When exposed to the salt of the antibody staining solution, the gel shrinks mostly in the thin dimension, facilitating rapid access to and penetration through the specimen by antibodies. After the sample is embedded in the stabilizing gel, it can be trimmed in one, two or three dimensions prior to further embedding in the immobilizing gel.

An immobilization gel monomer solution is provided. A UV initiator or chemical initiator is added to the monomer solution just before use. A gelation chamber is constructed, for example, as described in Example 3.

Immobilization gel monomer solution is added to the gelation chamber placed in a UV curing oven for 30 min, or until the immobilization gel has formed. In the time prior to gelation, the immobilization gel monomer solution diffuses into the gelled specimen from the sides. Oxygen dissolved in the monomer solution from room air delays gelation long enough for the monomer solution the diffuse in sufficiently to form a bond with the gelled specimen.

The immobilization gel is recovered and is optionally trimmed away from two immobilization gel edges to expose the gelled specimen without immobilization gel directly to excitation light from the side, if lightsheet imaging is desired.

The immobilization gel is superglued to a specimen holder, e.g. made from laser-cut acrylic resin. The specimen holder may be cut into a shape (e.g. a ‘C’ shape) that leaves the back face of the specimen open to allow antibodies or other affinity reagent to diffuse in from both faces. The sample is re-expanded in 1 mM HEPES for imaging.

All publications, patents, and patent applications mentioned in this specification are herein incorporated by reference to the same extent as if each individual publication, patent, or patent application was specifically and individually indicated to be incorporated by reference, including the references set forth in the following list:

### REFERENCES

1 Tillberg, P. W. et al. Protein-retention expansion microscopy of cells and tissues labeled using standard fluorescent proteins and antibodies. Nat. Biotechnol. 34, 987-992 (2016).
2. Ku, T. et al. Multiplexed and scalable super-resolution imaging of three-dimensional protein localization in size-adjustable tissues. Nat. Biotechnol. 34, 973-981 (2016).
3 Gambarotto, D. et al. Imaging beyond the super-resolution limits using ultrastructure expansion microscopy (UltraExM). bioRxiv 308270 (2018). doi:10.1101/308270

It will be understood that various details of the presently disclosed subject matter can be changed without departing from the scope of the subject matter disclosed herein. Furthermore, the foregoing description is for the purpose of illustration only, and not for the purpose of limitation.

What is claimed is:

1. A method of preparing a tissue sample for imaging a target biomolecule within the tissue sample with a targeting reagent, comprising:
(a) treating the tissue sample with a chemical fixative;
(b) treating the tissue sample with a first anchor for attaching the target biomolecule to a linear polymer to be synthesized subsequently;
(c) treating the tissue sample with a polymerization solution to be polymerized to generate the linear polymer, wherein the polymerization solution comprises
(i) first monomers, which are monomers of the linear polymer, and
(ii) a first component of a second anchor having: (1) a first moiety for incorporating into the linear polymer, and (2) a second moiety for reacting with a second component of the second anchor;
(d) allowing the first monomers in the solution to polymerize and link to the target biomolecule via the first anchor,
(e) treating the tissue sample with the second component of the second anchor having: (i) a first moiety that is reactive with the second moiety of the first component of the second anchor for engaging the first component of the second anchor, and (ii) a second moiety for incorporating into a swellable hydrogel;
(f) incubating the tissue sample with a gelation solution to be polymerized to generate a swellable hydrogel, wherein the gelation solution comprises (i) second monomers, which are monomers of the swellable hydrogel, and (ii) a cross-linker; and
(g) allowing the swellable hydrogel to form, wherein the second component of the second anchor is incorporated into the swellable hydrogel via the second moiety of the second component of the second anchor, thereby embedding the tissue sample and the target biomolecule within the swellable hydrogel.

2. The method of claim 1, wherein the second anchor comprises:
the first moiety of the first component of the second anchor that is an acryloyl moiety (Ac) for incorporating into the linear polymer;
the second moiety of the first component of the second anchor that is an azido moiety for reacting with the second component of the second anchor;
the first moiety of the second component of the second anchor that is an azido-reactive moiety for engaging the first component of the second anchor; and
the second moiety of the second component of the second anchor that is an acryloyl moiety (Ac) for incorporating into a swellable hydrogel.

3. The method of claim 1, and further comprising slicing the tissue sample before treatment with the second component of the second anchor.

4. The method of any one of claim 1, and further comprising expanding the swellable hydrogel.

5. The method of claim 4, and further comprising treating the tissue sample embedded within the swellable hydrogel with a disruption buffer prior to expanding the swellable hydrogel.

6. The method of claim 5, and further comprising contacting the tissue sample with a targeting reagent specific for the target biomolecule.

7. The method of claim 6, and further comprising imaging the tissue sample.

8. The method of claim 1, wherein the polymerization solution comprises an initiator to initiate polymerization and an accelerator to catalyze polymerization.

9. The method of claim 8, wherein the polymerization solution comprises an inhibitor to delay polymerization.

10. The method of claim 1, wherein the gelation solution comprises an initiator to initiate polymerization and an accelerator to catalyze polymerization.

11. The method of claim 10, wherein the gelation solution comprises an inhibitor to delay polymerization.

12. The method of claim 1, and further comprising placing the tissue sample embedded within the swellable hydrogel in a chamber and incubating with a stabilizing gelation solution comprising monomers of a swellable stabilizing gel.

13. The method of claim 12, wherein the stabilization gelation solution comprises a UV initiator or a chemical initiator, and a cross-linker.

14. The method of claim 12, and further comprising placing the tissue sample embedded within the swellable stabilizing gel in a chamber and incubating with an immobilization gelation solution comprising (i) monomers of an immobilization gel.

15. The method of claim 14, wherein the immobilization gelation solution comprises a UV initiator or a chemical initiator, and a cross-linker.

16. The method of claim 1, wherein the tissue sample is obtained from an animal.

17. The method of claim 16, wherein the tissue sample is an organ slice or a whole organ.

18. The method of claim 1, wherein the tissue sample is obtained from cultured cells.

19. The method of claim 1, wherein any combination of the fixative, first anchor, and polymerization solution are delivered to the specimen by transcardial perfusion.

20. The method of claim 1, wherein the target biomolecule is selected from the group consisting of a protein, a nucleotide, and a cell surface carbohydrate.
